(19) United States
(12) Patent Application Publication
(10) Pub. No.: US 2002/0131850 A1
(43) Pub. Date: Sep. 19, 2002

(54) Reticle transfer system

(76) Inventor: Hyun-Suk Yang, Suwon-city (KR)

Correspondence Address: VOLENTINE FRANCOS, PLLC, SUITE 150, 12200 SUNRISE VALLEY DRIVE, RESTON, VA, 20191, US

(21) Appl. No.: 10/092,349

(22) Filed: Mar. 7, 2002

(30) Foreign Application Priority Data
Mar. 8, 2001 (KR) 2001-12000

(51) Int. Cl. B65G 65/00

(52) U.S. Cl. 414/281

(57) ABSTRACT

A reticle transfer system includes a fork arm for withdrawing a reticle from a reticle cassette and transferring the reticule to a predetermined position, a linear carrier for temporarily holding the reticle transferred by the fork arm, and a position sensor for detecting the position of the reticle on the fork arm. The position sensor can detect an abnormal loading state of the reticle to prevent the reticle from being damaged. Additionally, an unpredictable error in a linear carrier can be prevented when the reticle is transferred from the fork arm to the linear carrier.

### BACKGROUND OF THE INVENTION

1. Field of the Invention

The present invention relates to photolithographic processes in the manufacturing of semiconductor devices. More particularly, the present invention relates to a reticle transfer system comprising a fork arm for transferring reticles used in a photolithographic process.

2. Description of the Related Art

Generally, photolithography in the manufacturing of semiconductor devices is predicated on the rendering of an image of (part of) an electronic circuit on a photographic plate. This photographic plate which bears the image of (part of) the electronic circuit is referred to as a photomask or a reticle. The photolithographic process prints the image on a silicon wafer on which a light-sensitive emulsion (e.g., a photoresist) has been applied. This process begins by exposing the light-sensitive emulsion to light that has been passed through the reticle. The exposed photoresist is developed to reveal a pattern corresponding to the desired circuit. Additional steps and treatments are used to transfer the pattern to a layer on the wafer and thereby form the structure of the circuit.

Referring to FIG. 1, a reticle 1 for use in photolithography is usually kept in a reticle cassette 3. A fork arm 7 moved by a transfer mechanism (not shown) extracts the reticle 1 from the reticle cassette 3 (S1), and transfers the reticle 1 to a linear carrier 9 (S2). The reticle 1 is finally transferred from the linear carrier 9 to a reticle exposing stage (not shown) by the transfer system.

When the reticle 1 is done being used, the linear carrier 9 holding the reticle 1 moves horizontally from the position P2 to the position P1, the fork arm 7 moves upward to receive the reticle 1, and then the fork arm 7 moves downward to put the reticle back into the reticle cassette 3. At the same time, the linear carrier 9 moves from the position P1 to the position P2.

However, when the reticle 1 is situated in the reticle cassette 3 in an abnormal position, the conventional fork arm 7 receives the reticle 1 in an incorrect disposition. As a result, the linear carrier 9 receives the incorrectly positioned reticle 1 from the fork arm 7 and thus, has difficulty in properly transferring the reticle 1.

Additionally, when the reticle 1 is situated in the reticle cassette 3 in an abnormal position and the fork arm 7 moves in to receive the reticle 1, the fork arm 7 can damage the reticle 1.

### SUMMARY OF THE INVENTION

An object of the present invention is to overcome the above-described problems of the prior art. more specifically, it is an object of the present invention to provide a reticle transfer system that can prevent a reticle from being damaged as it is transferred. It is another object of the present invention to prevent operation errors in a linear carrier for temporarily holding a reticle transferred thereto.

In order to achieve the above-described objects, the reticle transfer system of the present invention comprises a fork arm and a position sensor for sensing the position of a reticle supported on the fork arm. The fork arm is movable over a working range by which it can transfer a reticle from the inside of a reticle cassette to a predetermined position. A linear carrier temporarily holds the reticle transferred by the fork arm. The position sensor, by detecting the position of a reticle supported on the fork arm can discriminate whether the reticle is at a normal or abnormal position.

Therefore, the reticle transfer system will only transfer the reticle from a reticle cassette to a reticule exposing stage when the reticle is oriented in such a way as to ensure a smooth transfer operation.

### BRIEF DESCRIPTION OF THE DRAWINGS

These and other objects, features and advantages of the present invention will become more understood from the following detailed description of the preferred embodiment thereof made with reference to the accompanying drawings, in which like reference numerals denote like parts, and of which:

FIG. 1 is a perspective view of an essential portion of a conventional reticle transfer system;

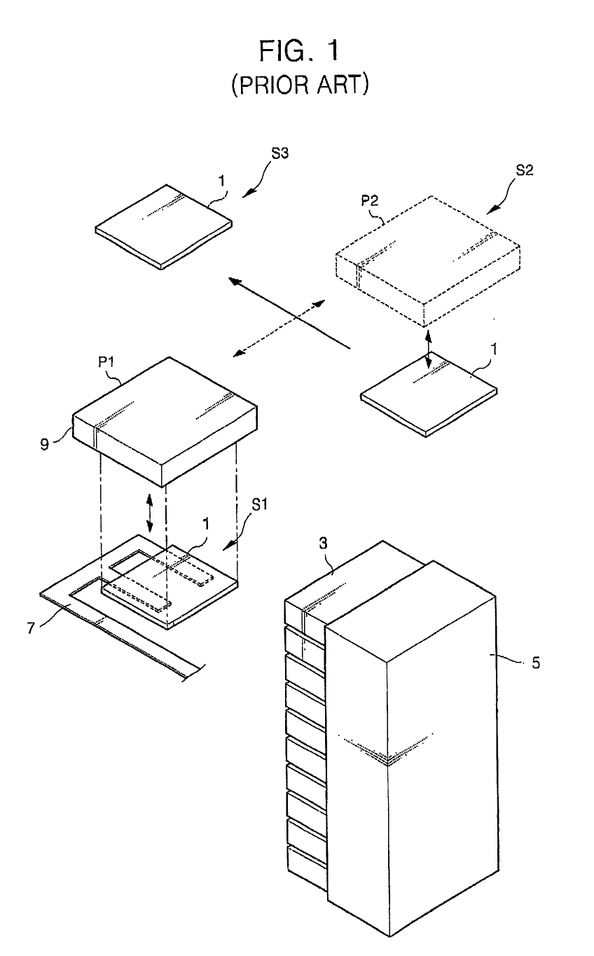

FIG. 2 is a perspective view of an essential portion of reticle transfer system according to the present invention;

FIG. 3 is a perspective view of the fork arm of the reticle transfer system shown in FIG. 2, in a state in which the fork arm supports a reticle; and

FIG. 4 is a perspective view of the linear carrier, taken from the bottom of the reticle transfer system shown in FIG. 2, in a state in which the linear carrier receives the reticle from the fork arm.

### DETAILED DESCRIPTION OF PREFERRED EMBODIMENTS

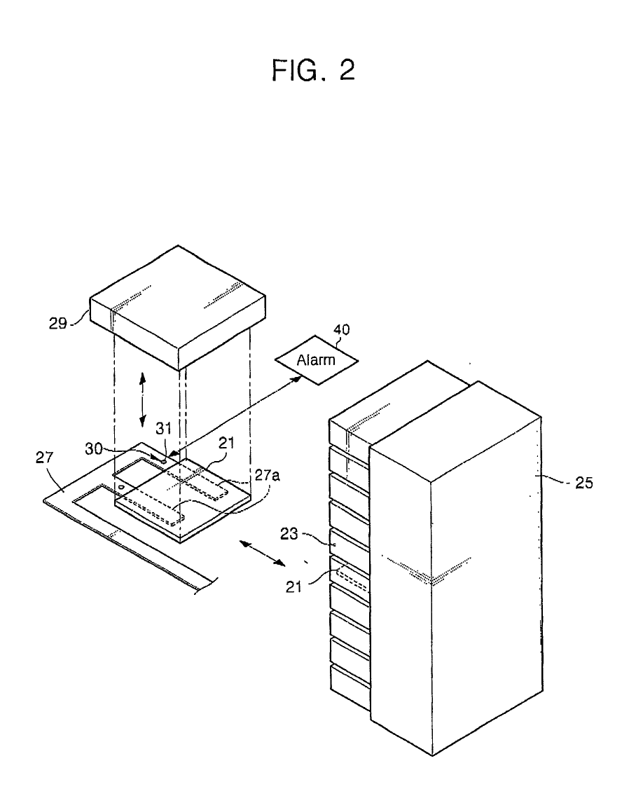

Referring to FIG. 2, a reticle cassette 23 having a reticle 21 is installed in a reticle library 25. A fork arm 27 of a transfer system is horizontally and vertically movable over a working range, as shown by the double-headed arrows, to extract the reticle 21 from a reticle cassette 23 at one side of the reticle library 25. A linear carrier 29, movable horizontally at the top of the reticle library 25, assumes a position within the working range of the fork arm 27 so that it may hold the reticle 21 temporarily before the reticle 21 is transferred from the fork arm 27 onto a reticle exposing stage (not shown).

The fork arm 27 comprises a plurality of tines 27a, and a position sensor 30 operable to detect the position of the reticle 21. More specifically, the position sensor 30 comprises a plurality of photo sensors 31 disposed at the base of the tines 27a, opposite to the fee ends of the tines 27 at which a reticle 21 is loaded onto the fork arm 27. Preferably, the sensitivity of the sensors 31 is adjustable in fine increments. The position sensor 30 detects the reticle 21 when the reticle 21 is situated incorrectly on the fork arm 27. An alarm 40, such as a light display or an audio buzzer, is operatively connected to the position sensor 30. The alarm is triggered by the position sensor 30 to indicate the abnormal state of the transfer operation.

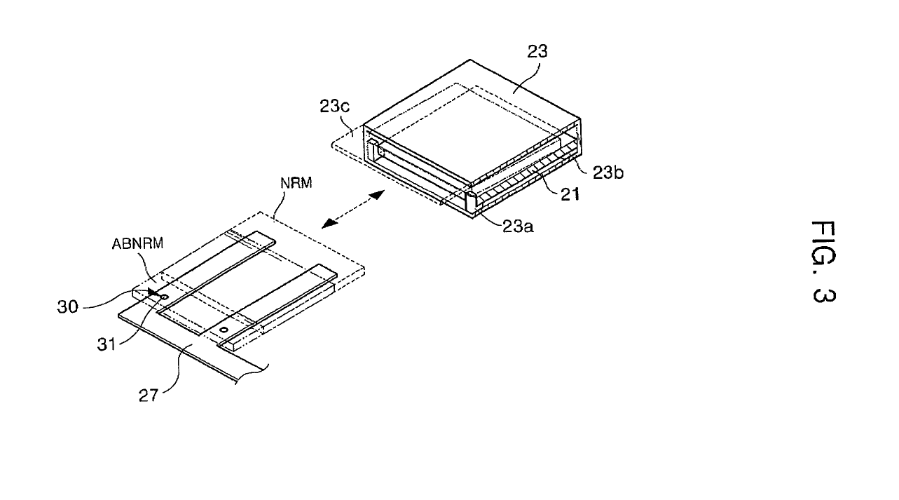

Referring to FIG. 3, the reticle cassette 23 comprises a case having a front opening, a cover 23c disposed over the front opening, and a linear guide bar 23b and an L-shaped guide bracket 23a disposed in the case at rear and front sides thereof, respectively. The linear guide bar 23b and L-shaped guide bracket 23a support the reticule 21 at a predetermined height off of the bottom of the case of the reticle cassette. The cover 23c is opened or closed automatically according to the state of transfer of the reticule 21.

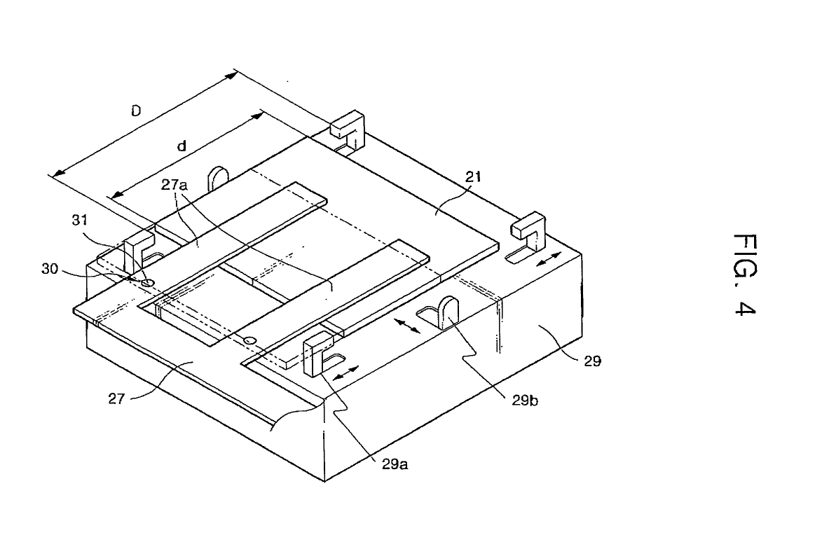

Referring to FIG. 4, the bottom of the linear carrier 29 comprises a supporting protrusion 29a and a fixing protrusion 29b. The supporting protrusion 29a includes at least one pair of L-shaped fingers disposed symmetrically with respect to each other and capable of being moved relative to each other in the same horizontal direction that the fork arm 27 moves. The supporting protrusion 29a is thus operable to grasp or release a reticle 21 while the reticle is transferred from or to the fork arm 27. The fixing protrusion 29b comprises at least a pair of upright I-shaped fingers disposed symmetrically and capable of being moved relative to each other in a direction orthogonal to that at which the fingers of the supporting protrusion 29a move. The fingers of the fixing protrusion are located midway between the fingers of each pair of the supporting protrusion 29a.

The pair of fingers of the supporting protrusion 29a can be spaced apart by a maximum distance D larger than the width d of the reticle. The fingers of the fixing protrusion 29b move toward or away from each other in the direction of the arrows shown in FIG. 4 to fix the reticule 21 in place on the bottom of the linear carrier 29 when the reticle 21 is loaded in a correct relative position on the linear carrier 29.

The above-described reticle transfer system according to the present invention operates as follows.

Referring to FIG. 3, the fork arm 27 is moved horizontally by a transfer mechanism into the reticle cassette 23 to receive the reticle 21. As the fork arm 27 is being inserted into the reticule cassette 23, the cover 23c of the reticle cassette 23 is opened by a cover operating mechanism. Once inside the cassette 23, the fork arm 27 is moved upward into contact with the reticle 21, whereupon the position sensor 30 of the fork arm 27 senses for the presence of the reticle 21.

If the reticle 21 inside of the reticle cassette 23 is positioned normally relative to the fork arm 27, the position sensor 30 in the fork arm 27 does not detect the reticle 21. That is, the reticle 21 will be located on the fork arm 27 in the “NRM” state shown in FIG. 3. In this case, the fork arm 27 will be moved upward and outward to withdraw the reticle 21 from the reticle cassette 23. Next, the fork arm 27 is moved upward towards the bottom of the linear carrier 29. In this case, the linear carrier 29 has already been moved into position for receiving the reticle 21 from the fork arm 27.

Referring now again to FIG. 4, once the reticle 21 arrives at a predetermined position relative to the linear carrier 29, the L-shaped fingers of the supporting protrusion 29a move toward each other symmetrically. The supporting protrusion 29a does not prevent the linear carrier 29 from receiving the reticle 21 because the distance D between the fingers of the supporting protrusion 29a is larger than the width d of the reticule 21. At the same time, the I-shaped fingers of the fixing protrusion 29b move toward the center of the linear carrier 29 to pinch the reticle 21 therebetween. As soon as the supporting protrusion 29a and the fixing protrusion 29b take hold of the reticle 21, the fork arm 27 releases the reticle 21 and moves downward.

Hence, as described above, the transporting process progresses smoothly without error when the reticle 21 is situated normally within the reticle cassette 23.

On the other hand, the reticle 21 can be situated abnormally within the reticle cassette 23 due to some mistake in putting the reticle cassette 23 in the reticle library 25, such as an operation in which the reticle cassette 23 experiences an unusually large impact. In this case, the reticle 21 is incorrectly positioned on the fork arm, assuming an “ABNRM” state as shown in FIG. 3. in this case, the position sensor 30 in the fork arm 27 detects the presence of the reticle 21 on the fork arm.

More specifically, the photo sensors 31 operate according to well-known principles. A pulse of modulated light is emitted from a luminance element of the photo sensor 31. The quantity of the light incident on a photo detector is reduced to due to the presence of the reticle. As a result, a rectifying signal level of the incident light is at such a low operation level that an output signal is issued. The output signal triggers the alarm, e.g., causes an alarm buzzer to sound or a light display to illuminate. At the same time, the fork arm 27 moves out from the reticle cassette 23 and is re-initialized.

Next, the reticle 21 is repositioned in the reticle cassette 23 and is transferred according to the above described operation.

As described above, the fork arm 27 has a position sensor 30 by which the state in which the reticle is received by the fork arm can be determined to prevent the reticle from being damaged. Additionally, an unpredictable error in a linear carrier can be prevented when the reticle is transferred from the fork arm to the linear carrier.

Finally, although the present invention has been shown and described with reference to the preferred embodiments thereof, various changes in form and details, as will become apparent to those of ordinary skill in the art, may be made thereto without departing from the true spirit and scope of the invention as defined by the appended claims.

What is claimed is:

1. A reticle transfer system comprising:
a fork arm comprising a plurality of tines for supporting a reticle;
a linear carrier having a gripper for temporarily holding the reticle transferred by the fork arm; and
a sensor disposed on the fork arm and operable to detect the presence of a reticule at a given position relative to the fork arm.

2. A reticle transfer system as claimed in claim 1, and further comprising an alarm operatively connected to said position sensor so as to generate an alarm signal when the position sensor detects a reticle on the fork arm at said given position.

3. A reticle transfer system as claimed in claim 1, wherein the position sensor comprises a plurality of photo sensors disposed, respectively, at base ends of said tines opposite free ends of said tines.

4. A reticle transfer and storage system, comprising
a reticle library;
a plurality of reticle cassettes supported in said reticle library;
a fork arm disposed adjacent said cassettes, said fork arm comprising a plurality of tines for supporting a reticle, and said fork arm being movable horizontally and vertically in a working range that encompasses the interior of each of said cassettes so as to be capable of withdrawing a reticle stored in any of said cassettes;
a linear carrier disposed outside of said library and movable to a position within the working range of said fork arm, said linear carrier having a gripper for temporarily holding a reticle withdrawn from a said cassette by the fork arm; and
a sensor disposed on the fork arm and operable to detect the presence of a reticule at a given position relative to the fork arm.

5. A reticle transfer and storage system as claimed in claim 4, and further comprising an alarm operatively connected to said position sensor so as to generate an alarm signal when the position sensor detects a reticle on the fork arm at said given position.

6. A reticle transfer system as claimed in claim 4, wherein the position sensor comprises a plurality of photo sensors disposed, respectively, at base ends of said tines opposite free ends of said tines.
